(19) United States
(12) Patent Application Publication
(10) Pub. No.: US 2023/0379715 A1
(43) Pub. Date: Nov. 23, 2023

(54) SYSTEM AND METHOD FOR DETECTING MALICIOUS ACTIVITY IN A USER EQUIPMENT POSITIONING SIGNAL USING A POSITION COMPARATOR

(71) Applicant: WI-LAN RESEARCH INC., Vista, CA (US)

(72) Inventors: Arslan Mumtaz, Islamabad (PK); Zain Noman, Islamabad (PK); Rashad Ramzan, Islamabad (PK); Muddassar Farooq, Islamabad (PK); Kenneth Stanwood, Vista, CA (US)

(73) Assignee: WI-LAN RESEARCH INC., Vista, CA (US)

(21) Appl. No.: 18/306,332

(22) Filed: Apr. 25, 2023

Related U.S. Application Data
(60) Provisional application No. 63/343,785, filed on May 19, 2022.

(51) Int. Cl. H04W 12/122; H04W 12/63

(52) U.S. Cl. CPC H04W 12/122; H04W 12/63; H04W 84/06

(57) ABSTRACT

A method and system for detecting a malicious change in the positioning signal of a User Equipment (UE), by using the time difference of arrival (TDOA) method in a communication system that uses, for example, a low earth orbiting satellites (LEOs) based non-terrestrial network (NTN). A position comparator module is incorporated in a position computation entity that compares the geolocation of a UE, computed by using the transmitted time Tₜᵣₐₙₛ in the positioning signal, with the geolocation computed by the TDOA method, and if the difference is above a threshold value, an alert is generated. Using this system a and method prevents a UE from faking its own geolocation to other UEs and communication devices in the communication system by more than few hundred of meters. As a result, the Location Based Services (LBS) can be offered reliably to legitimate users only.

### CROSS REFERENCE TO RELATED APPLICATIONS

This application is a utility application of and claims priority to U.S. Provisional Patent Application Ser. No. 63/343,785, filed May 19, 2022, and titled SYSTEM AND METHOD TO DETECT THE MALICIOUS ACTIVITY IN THE POSITIONING SIGNAL USING A POSITION COMPARATOR, the disclosure of which is incorporated herein by reference.

### FIELD OF THE INVENTION

The concept described herein discloses a system and method to detect a malicious or defect-caused change in the positioning signal of a User Equipment (UE), using the time difference of arrival (TDOA) method in a communication system that uses a low earth orbiting satellites (LEOs) based non-terrestrial network (NTN). The falseness or misrepresentation of geolocation coordinates of a UE is detected and hence the reliability of geolocation coordinates of a wireless communication device is significantly enhanced in advanced wireless communication systems such as 5G, 6G, and industry 4.0. Using the disclosed concept, a UE cannot fake its own geolocation to other UEs and communication devices in the communication system by more than a few hundred meters. As a result, the Location Based Services (LBS) can be offered reliably to legitimate users at their true geolocation.

### BACKGROUND OF THE INVENTION

Current and future wireless and mobile communication systems are planned to have a high data rate and ubiquitous global connectivity that will result in an exchange of data among trillions of devices, including but not limited to smart devices such as wearable smart healthcare devices, IoT sensors and control devices, and e-commerce and Fintech nodes including digital wallets. These devices demand ultra-reliable and low latency communication networks. The terrestrial network infrastructure and traditional mobile wireless networks alone might not be able to meet the demands of such systems. NTNs such as Starlink are already being deployed, and the third-generation partnership project (3GPP) recommends using LEOs in 5G networks and beyond.

For many application use cases of 5G/6G networks and beyond, it is desirable to ascertain the accurate location of devices, collectively referred to as user equipment (UE) hereafter. Satellite-based location systems such as the US Global Positioning System (GPS) or the European Global Navigation Satellite System (GNSS), though ubiquitously available, are unable to provide a reliable method to UEs to securely determine their geolocation. It is already demonstrated that a malicious entity can transmit fake GPS signals, causing a device to think it is at a location where it is not. This attack could be applied, for instance, to delivery drones to cause them to deliver their cargo to the wrong location. It is desirable to have a system and method that allows a device to be confident of its true geolocation. The method described in “Secure Location of Wireless Devices Using LEO Satellite Assistance”, that is a co-pending U.S. patent application 63/266,487 (which is included by reference) proposes a novel method to compute the geolocation of UE when GPS signals cannot be trusted.

In U.S. patent application 63/266,487, the uplink Tx timing advance is maintained by a serving cluster member satellite (CMS) using timing advance commands that are sent to a UE. These timing advance commands are based on the measurements on the uplink transmissions received from that UE. For example, the serving CMS measures for each UE, the difference between the time when each UE is scheduled to transmit and when that transmission is received by the serving satellite to determine the value of the timing advance required for a particular UE. Therefore, the UE should transmit early, by the amount of its Tx Time Advance, such that its transmissions are received at the serving satellite at its expected time. Generally, applications and users are allowed to access and control networking drivers, firmware, and hardware registers on UEs. This can be exploited by malicious entities to control, inspect, or alter information transmitted, received, or processed by the UE including the time information, for instance by manipulating time registers. Such malicious entities may, for instance, change the one-way transmission time by delaying or advancing the transmission of the signal to the serving CMS relative to when they should transmit based on the Tx time advance. In these scenarios, CMSs will calculate an incorrect time of transmission (Tₜᵣₐₙₛ) for that particular UE and assign an incorrect new Tx timing advance. Alternatively, if the UE transmits a fake Tₜᵣₐₙₛ, it will also result in an incorrect distance calculation at CMSs, both an incorrect Tx time advance and an incorrect Tₜᵣₐₙₛ will result in calculating incorrect geolocation coordinates using the trilateration method. Thus, by transmitting at a time different than expected by the CMSs, a malicious entity can make a UE appear to be at a different location than it really is. Additionally, a malicious entity may attack a UE by masquerading a UE located at a different position to appear to be the UE under attack. Consequently, a UE might be tricked into believing the incorrect geolocation coordinates to be its true coordinates, or the system may be tricked into thinking the UE is at a different location than it is.

### SUMMARY

A system and method for detecting a malicious or defect-caused change in the positioning signal that is transmitted by UEs to the communication system comprising of NTN using LEOs is described. As a result, a UE cannot fake its geolocation coordinates by more than a few hundred meters. A position comparator module is incorporated in the position computation entity that compares the geolocation of a UE, computed by using trilateration based upon the Tx time advance, of the positioning signal as described in U.S. patent application 63/266,487, with the geolocation computed by using Time Difference of Arrival (TDOA) of the same positioning signal. If the difference is above a threshold value, an alert is generated. As a result, the UE's ability to fake its own geolocation by applying an incorrect Tx Time Advance or declaring an incorrect Tₜᵣₐₙₛ is bounded by an upper bound that is determined by the accuracy of the TDOA method. The position computation entity may reside in any one of the following: UE, a satellite nominated as cluster head satellite (CHS) out of the set of cluster member satellites (CMSs) including the serving CMS, a ground station or other operator equipment, or on computing devices in the cloud.

A position comparator is comprised of a true range geolocator that computes the geolocation by using trilateration method and pseudo range geolocator that computes the geolocation by using TDOA method. A selector module in the position comparator is incorporated, before the pseudo range geolocator, to select the signals from a cluster of CMSs, in order to minimize the dilution of precision. This can be achieved by ensuring that the information of Time of Flight (ToF) is used in the geolocation computation from those CMSs whose geometry is not coplanar. The precision of TDOA decreases if the satellites involved are coplanar. CMSs should transmit Tₐᵣᵣᵢᵥ of the positioning signal from a particular UE and their own orbital position at Tₐᵣᵣᵢᵥ to the position computation entity to enable it to apply the TDOA method to verify the position of a UE. Once the geolocation coordinates of a UE are verified, the pseudo range geolocator of the position comparator in the position computation entity need not to run all the time. Once the geolocation is verified, then position computation may be performed in any of a variety of other ways, including trilateration using the expected transmit time or GPS. However, whenever the system is in doubt of the UE geolocation, it can invoke TDOA method as a validation check.

### BRIEF DESCRIPTION OF THE DRAWINGS

The accompanying drawings, which are incorporated in and constitute part of this specification, illustrate embodiments of the disclosed concept and, together with the description, serve to explain the principles of the disclosed concept. The embodiments herein illustrate the disclosed concept for NTN composed of LEOs; however, it can be adapted to other NTNs such as those using unmanned aircraft systems (UAS) or high-altitude platforms (HAPs). Furthermore, the embodiments illustrated herein are presently preferred, it being understood by those skilled in the art, however, that the disclosed concept is not limited to the precise arrangements and instrumentalities shown, wherein:

FIG. 1 is a system level illustration of the method where the geolocation of a UE is computed by LEO satellites using Time Difference of Arrival (TDOA) method.

FIG. 2 is a functional block diagram of a position computation entity that gathers the positioning signal data and computes the position of a UE;

FIG. 3 is a functional block diagram of a position comparator that compares the position of UE computed using trilateration method with the position computed using TDOA method;

FIG. 4 is a flow graph of the method, used by the position computation entity, for calculating geolocation coordinates and detecting malicious change, if made, in geolocation by malicious entities;

FIG. 5 is an aspect of the disclosed concept that describes the method used in pseudo range geolocator for finding the geolocation by using the TDOA method;

FIG. 6 displays a two-dimensional view of a UE's geolocation that is calculated by the intersection of the branches of hyperbolas that are formed by four CMSs.

FIG. 7 shows the determination of threshold for determining whether Tₜᵣₐₙₛ is maliciously altered by a malicious entity.

### DETAILED DESCRIPTION

The figures and their corresponding embodiments provided in this disclosure are aspects of the present disclosed concept, and their advantages may be understood by referring to the figures and the following description. The descriptions and features disclosed herein can be applied to accurately determine the geolocation of UE in NTNs deployed using LEOs. However, it can be adapted to other NTNs such as those using UAS or HAPs. Henceforth, the figures and embodiments depicted are for the sole purpose of clarity and by any means do not limit the scope of the disclosed concept.

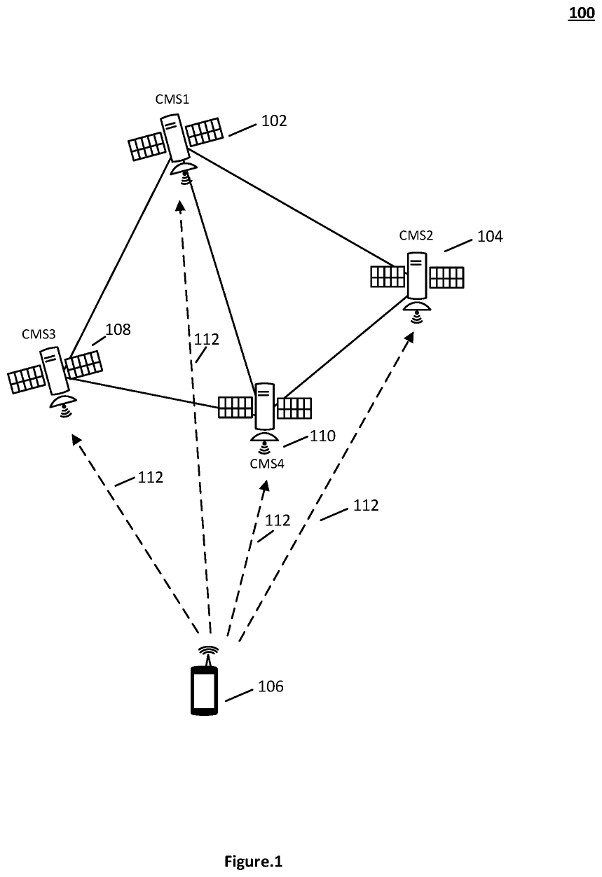

FIG. 1 is a system level illustration of the method where the geolocation of UE 106 is computed by LEO satellites using Time Difference of Arrival (TDOA) method. The UE 106 transmits signal 112 used for positioning to CMSs in a non-terrestrial communication network. The transmitted signal 112 should be received by a minimum of four CMSs such as CMS1 102, CMS2 104, CMS3 108 and CMS4 110. One of the CMSs that received the signal 112 of UE 106 acts as the serving CMS for that UE 106; while the remaining CMSs act as other CMSs. Each CMS records the time of arrival Tₐᵣᵣᵢᵥ of signal 112. In an aspect, the four CMSs should not be coplanar so that the dilution of precision is minimized. It is known to those skilled in the art that coplanar geometry of CMSs can be avoided by using signals from CMSs that form a tetrahedron with the largest volume. If the volume of the tetrahedron formed by considering CMSs at its vertices is zero then it indicates that all the CMSs are coplanar; and hence may not participate in computing geolocation using the TDOA method.

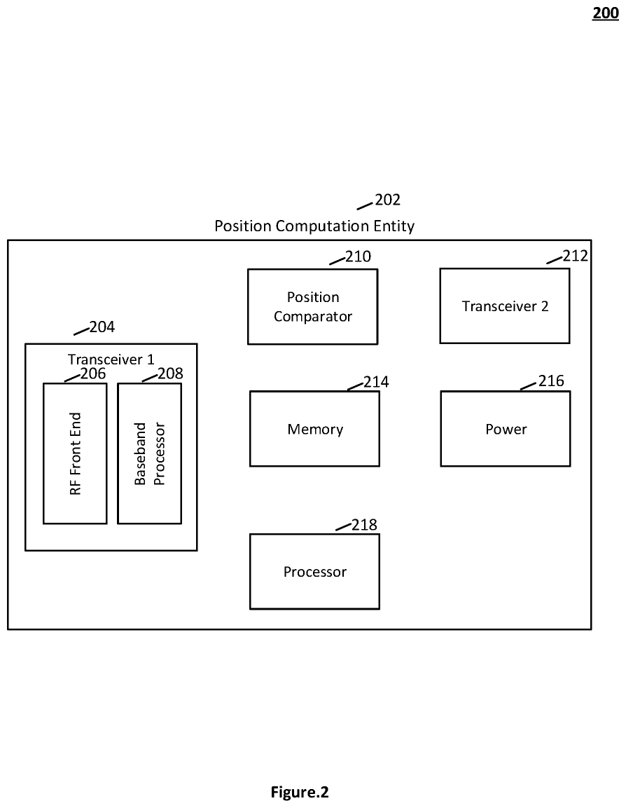

FIG. 2 is a functional block diagram of position computation entity 202 that receives the information of the positioning signal such as Tₐᵣᵣᵢᵥₐₗ of the signal 112 received by serving CMS and other CMSs and computes the position of UE 106. Position computation entity 202 may reside in any one of the following: UE 106, a satellite nominated CHS chosen from among the set of serving CMS and other CMSs, a ground station or other operator equipment, or computing devices housed in the cloud as explained in “Secure Location of Wireless Devices Using LEO Satellite Assistance”, that is a co-pending U.S. patent application 63/266,487 (which is included by reference). Position computation entity 202 is comprised of a first transceiver 204 to communicate with the serving CMS and other CMSs; a position comparator 210 to compute and verify the geolocation of UE 106; a second transceiver 212 to communicate with the geolocation databases; a processor 218 for processing signals and running geolocation calculation methods; memory 214 for providing storage for software, firmware, and data; and power module 216 that powers the position computation entity 202. Position comparator 210 is at the core of the disclosed concept, as it detects maliciously modified positioning signals, used in the co-pending U.S. patent application 63/266,487, by comparing geolocation coordinates of UE 106 that are computed by using the Time of Flight (ToF) method with those computed by the TDOA method. First transceiver 204 further comprises an RF frontend 206 that receives positioning signal at Tₐᵣᵣᵢᵥ that is transmitted by UE 106 at Tₜᵣₐₙₛ to serving and other CMSs. Serving CMS transmits its own position and Tₜᵣₐₙₛ, that is computed from the Tx time advance, and Tₐᵣᵣᵢᵥ of signal to position computation entity 202. Whereas other CMSs only transmit the Tₐᵣᵣᵢᵥ of positioning signals and their positions at Tₐᵣᵣᵢᵥ to position computation entity 202. Baseband processor 208 inside first transceiver 204 of position computation entity 202 transmits Tₜᵣₐₙₛ and Tₐᵣᵣᵢᵥ of serving CMS and other CMSs and the positions of all CMSs to true range geolocator module 308 of position comparator 210 that runs trilateration method. Furthermore, baseband processor 208 transmits only Tₐᵣᵣᵢᵥ and position of CMSs to CMSs' configuration selector module 318 that filters the signals to use by pseudo range geolocator module 310 of position comparator 210 that runs the TDOA method.

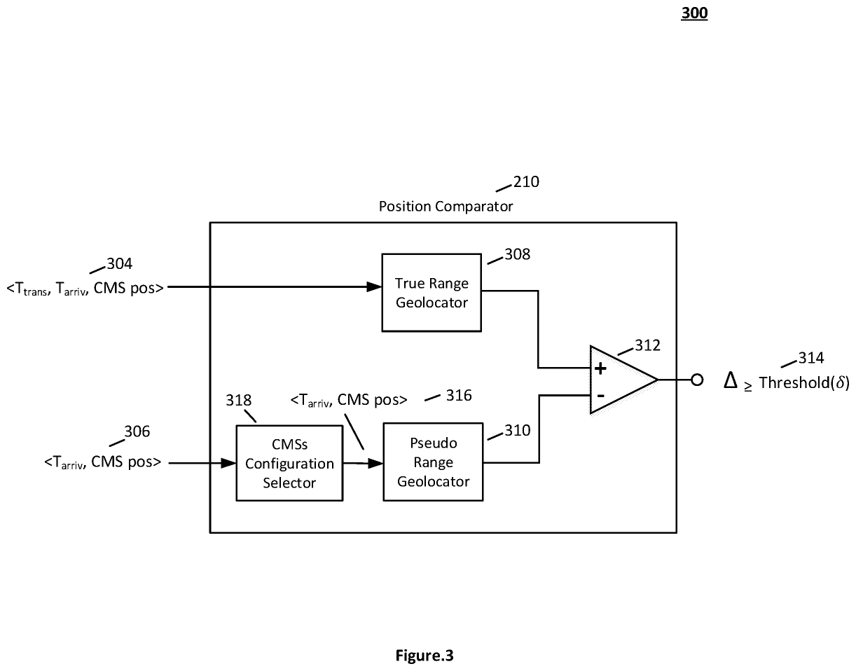

FIG. 3 is a functional block diagram of a position comparator 210 that compares the position of UE 106 computed by using trilateration method with the position computed by using the TDOA method. Consequently, it can determine whether Tₜᵣₐₙₛ in the positioning signal, transmitted by UE 106 or Tx time advance of UE calculated by serving CMS, was maliciously altered by a malicious entity. Position comparator 210 is comprised of a true range geolocator 308 that computes the geolocation by using the trilateration method; a pseudo range geolocator 310 that computes the geolocation by using the TDOA method; a CMSs configuration selector 318 to select the configuration of CMSs to minimize the dilution of the precision; and a difference calculator 312 that computes the absolute difference of the geolocation coordinates computed by true range geolocator 308 and pseudo range geolocator 310. CMSs configuration selector 318 receives an array of tuples 306 comprised of <Tₐᵣᵣᵢᵥ, CMS positions> at Tₐᵣᵣᵢᵥ and only forwards signals of those CMSs which give minimum possible dilution of precision for the TDOA method by using methods known to those skilled in the art. True range geolocator 308 receives an array of tuples 304 comprising of <Tₜᵣₐₙₛ, Tₐᵣᵣᵢᵥ, CMS position> at Tₐᵣᵣᵢᵥ whereas pseudo range geolocator 310 receives an array of tuples 316 comprising of <Tₐᵣᵣᵢᵥ, CMSs positions> at Tₐᵣᵣᵢᵥ. The geolocation computed by true range geolocator 308 is compared with the one that is computed by pseudo range geolocator 310 by feeding them to difference calculator 312 that finds the absolute difference in geolocation coordinates of UE 106. Condition 314 represents the criterion to detect whether the value of Tₜᵣₐₙₛ transmitted by a UE 106 or calculated Tx time advance is maliciously altered by a malicious entity or not. If the difference calculated by difference calculator 312 is less than a threshold, then the value of Tₜᵣₐₙₛ or Tx time advance is not altered by a malicious entity, else Tₜᵣₐₙₛ or Tx time advance is maliciously altered and thus position computation entity 202 must alert the serving CMS about it.

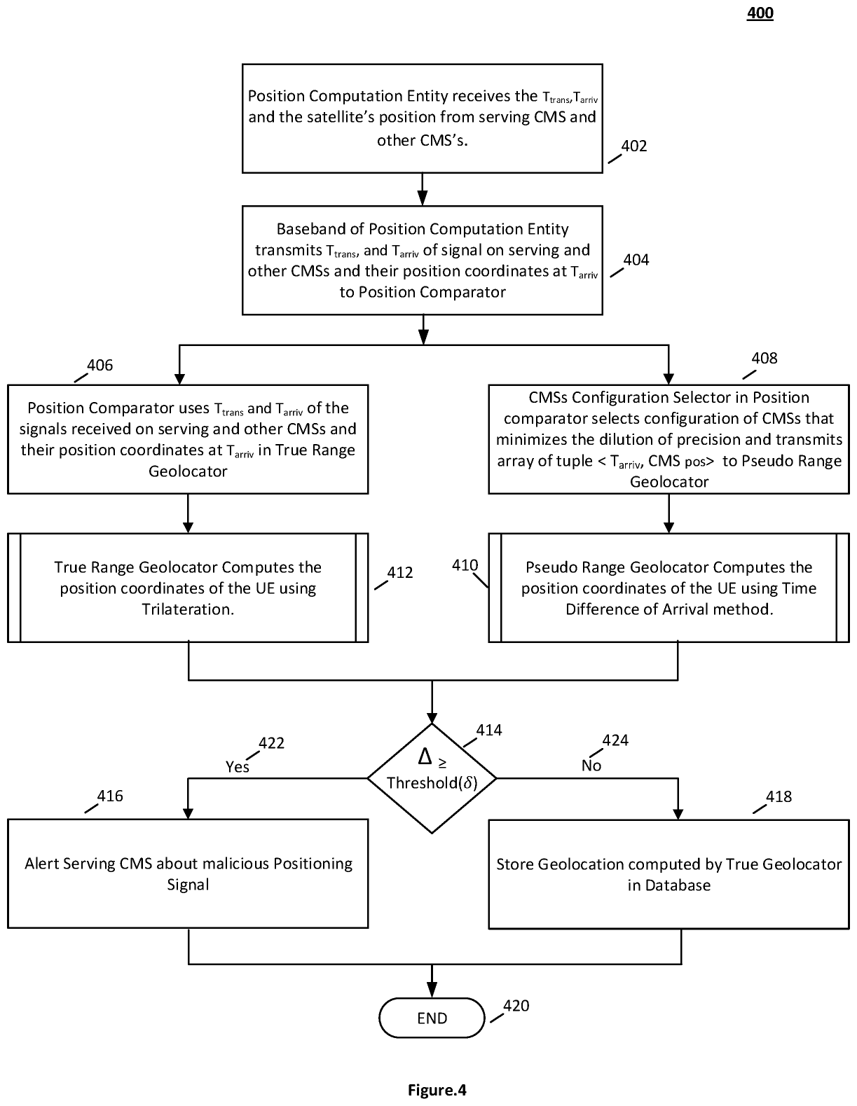

FIG. 4 is a flow graph of the method, used by position computation entity 202, for calculating geolocation coordinates and detecting malicious changes in geolocation by malicious entities. In step 402, the position computation entity 202 receives <Tₜᵣₐₙₛ, Tₐᵣᵣᵢᵥ, CMS pos> tuple from serving CMS and other CMSs at Tₐᵣᵣᵢᵥ. In step 404, baseband processor 208 of first transceiver 204 of position computation entity 202 transmits Tₜᵣₐₙₛ and Tₐᵣᵣᵢᵥ of the signals received on serving CMSs and other CMSs as well as their position coordinates at Tₐᵣᵣᵢᵥ to position comparator 210. In step 406, position comparator 210 uses Tₜᵣₐₙₛ and Tₐᵣᵣᵢᵥ of the positioning signals received on serving and other CMSs and their position coordinates at Tₐᵣᵣᵢᵥ in true range geolocator 308. In step 412, true range geolocator 308 first computes the ToF by computing the difference in Tₐᵣᵣᵢᵥ and Tₜᵣₐₙₛ as it is assumed that the clocks of UEs and CMSs are synchronized. Using ToF, it can compute the true geolocation coordinates of UE 106 by solving non-linear over determined system of equations with the help of iterative gauss newton or other numerical methods well known to the ones skilled in the art. In step 408, CMSs configuration selector 318 of position comparator 210 uses the position coordinates of CMSs at Tₐᵣᵣᵢᵥ to select the configuration of CMSs that minimizes the dilution of precision; it then transmits filtered array of tuple <Tₐᵣᵣᵢᵥ, CMS pos> 316 to pseudo range geolocator 310. In pseudo range geolocator 310, geolocation coordinates of UE 106 are computed by using the TDOA method in step 410. Since in this method, Tₜᵣₐₙₛ is not used to compute the exact time of flight; therefore, the geolocation coordinates as computed by pseudo range geolocator 310 might have clock offset error. To reduce errors due to the geometry of CMSs, Tₐᵣᵣᵢᵥ from only those CMSs are used by pseudo range geolocator 310 that reduce the dilution of precision. Therefore, the error in geolocation is bounded within few hundreds of meters as reported in the prior art. Thus, a malicious entity cannot impersonate another UE that is more than few hundreds of meters away or can misrepresent its own geolocation within this bound only. In decision box 414, the condition 314 is evaluated and if the difference exceeds a threshold, as indicated by the flag “yes” in 422, position computation entity 202 is required to alert the serving and other CMSs that UE 106 is faking its positioning signal in step 416. Whereas, if the difference does not exceed the threshold indicated by the flag “No” in 424, position computation entity 202 transmits the geolocation coordinates to the database in step 418. The process ends in step 420.

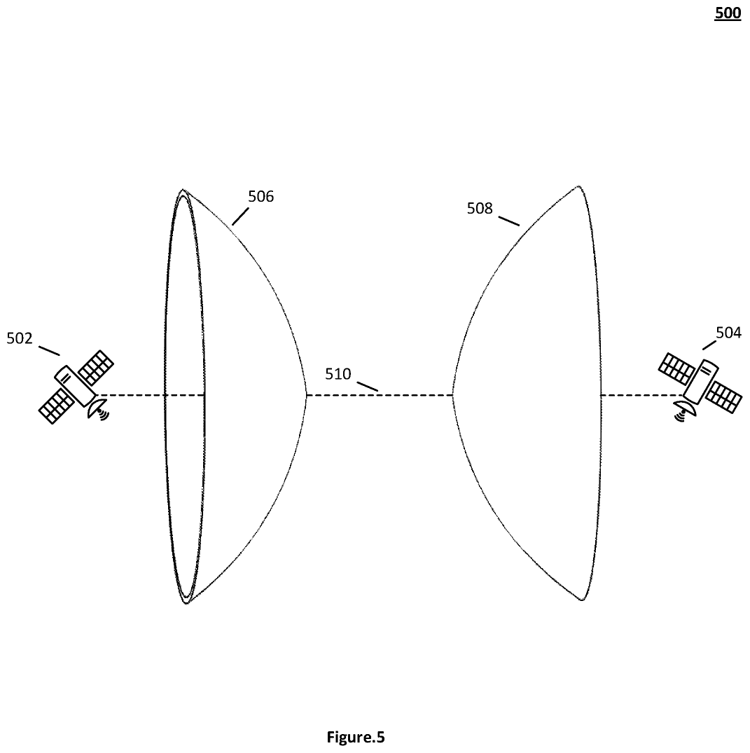

FIG. 5 is an aspect of the disclosed concept that describes the method used in pseudo range geolocator 310 for finding the geolocation coordinates by using the TDOA method. The signal from UE 106 arrives at different CMSs at different times if each CMS is located at a different position in a constellation of LEO satellites. Given two CMSs 502 and 504 that are at different locations, the difference in Tₐᵣᵣᵢᵥ now can be easily computed. The clocks on each of the CMSs are assumed to be synchronized with the UTC standard. A hyperboloid is formed by visualizing the time difference of arrival. Tₐᵣᵣᵢᵥ for CMS 504 is:

$${T}_{{arriv}_{504}} = {T}_{trans} + \frac{‖ CM \vec{{S}_{{Pos}_{504}}} - \vec{{UE}_{Pos}} ‖}{c} \qquad ( 1 )$$

Where CMS_Pos₅₀₄ is the position of CMS 504. Similarly, Tₐᵣᵣᵢᵥ for CMS 502 is:

$${T}_{{arriv}_{502}} = {T}_{trans} + \frac{‖ \vec{{CMS}_{{Pos}_{502}}} - \vec{{UE}_{Pos}} ‖}{c} \qquad ( 2 )$$

Where c is the speed of light and CMS_Pos₅₀₂ is the position of the CMS 502. Subtracting equations (1) and (2), we get

$${T}_{{arriv}_{504}} - {T}_{{arriv}_{502}} = \frac{‖ \vec{{CMS}_{{Pos}_{504}}} - \vec{{UE}_{Pos}} ‖}{c} - \frac{‖ \vec{{CMS}_{{Pos}_{502}}} - \vec{{UE}_{Pos}} ‖}{c} \qquad ( 3 )$$

510 is the axis of symmetry, where CMS 502 and CMS 504 are located at the foci of the hyperboloid. One skilled in the art would understand that the locus of UE 106 position is either on branch 506 or branch 508 of the hyperboloid. To determine the location of UE 106, using the TDOA technique, consider another CMS located at a different location. Now three CMSs will provide two TDOAs. With two TDOAs, UE 106 can be located on the curve determined by the two intersecting hyperboloids. If Tₐᵣᵣᵢᵥ is also obtained from a fourth CMS, three independent TDOAs and thus three hyperboloids are formed. Solving three simultaneous equations in the three-dimensional space will compute the geolocation of UE 106.

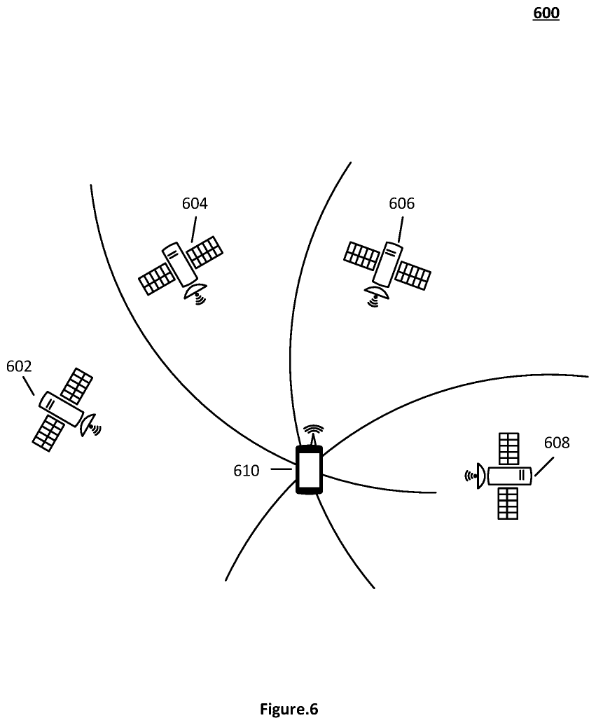

FIG. 6 displays a two-dimensional view of such a point calculated by the intersection of branches of the hyperbolas formed by the four CMSs 602, 604, 606, and 608 respectively. Intersection point 610 corresponds to the geolocation coordinates of UE 610.

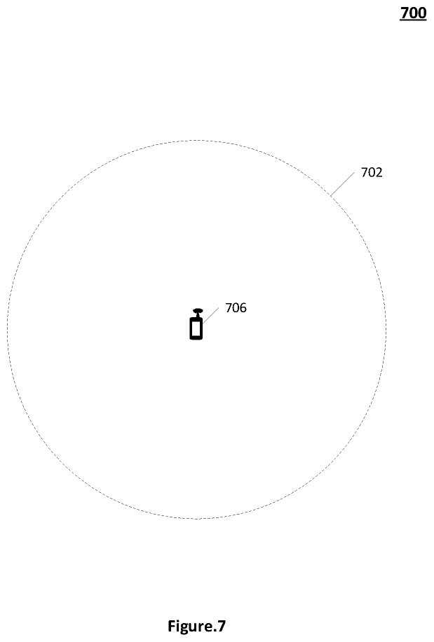

FIG. 7 illustrates the upper bound on the geolocation coordinates that a malicious entity can misrepresent to a serving CMS. For example, a UE 706 can only misrepresent its geolocation coordinates or impersonate the geolocation coordinates of other devices within the area that is bounded by circle 702 once the TDOA method is used. If UE 706 tries to misrepresent its geolocation coordinates outside circle 702 or impersonate devices that are outside circle 702, then with the help of TDOA method this malicious misrepresentation is detected.

The upper bounds may also vary dynamically whenever dilution of precision (DOP) changes. DOP in itself is not a measure of error in geolocation; rather it shows how severely the geolocation coordinates are affected if random errors emerge in a configuration of satellites. To obtain DOP values, we first have to find the covariance matrix denoted here as Q using:

Q=(A^{T}A)⁻¹ (4)

Where A^{T} is the transpose of the matrix A. For TDOA:

$$A = [ \begin{matrix}\frac{( {x}_{1} - x )}{{R}_{1}} & \frac{( {y}_{1} - y )}{{R}_{1}} & \frac{( {z}_{1} - z )}{{R}_{1}} & - C \\ \frac{( {x}_{2} - x )}{{R}_{2}} & \frac{( {y}_{2} - y )}{{R}_{2}} & \frac{( {z}_{2} - z )}{{R}_{2}} & - C \\ \frac{( {x}_{3} - x )}{{R}_{3}} & \frac{( {y}_{3} - y )}{{R}_{3}} & \frac{( {z}_{3} - z )}{{R}_{3}} & - C \\ ⋮ & ⋮ & ⋮ & ⋮\end{matrix} ] \qquad ( 5 )$$

Where x, y, z are the coordinates of UE and xₙ, yₙ and zₙ are the coordinates of the CMS satellites, where n depends on the number of receiving CMSs. Rₙ is the distance of UE from n^{th} CMS and C is the speed of light. The matrix A is used in finding the geolocation iteratively by executing Gauss Newton or any other similar method. The obtained Q matrix is a 4×4 matrix in the case of TDOA. The Q matrix for the TDOA case is:

$$Q = [ \begin{matrix}{σ}_{x}^{2} & {σ}_{x y} & {σ}_{x z} & {σ}_{xt} \\ {σ}_{x y} & {σ}_{y}^{2} & {σ}_{yt} & {σ}_{yt} \\ {σ}_{x z} & {σ}_{z y} & {σ}_{z}^{2} & {σ}_{zt} \\ {σ}_{xt} & {σ}_{yt} & {σ}_{zt} & {σ}_{t}^{2}\end{matrix} ] \qquad ( 6 )$$

Where σₓ², σ_{y}², σ_{z}² and σₜ² are variances in x, y, z and t dimensions. σ_{xy} is covariance of x and y distances in x and y dimensions and without loss of generality the other covariances represent the covariance in their respective dimensions as well. The multiple DOP values are obtained from the diagonal entries of the covariance matrix Q:

PDOP=\sqrt{σₓ²+σ_{y}²+σ_{z}²} (7)

HDOP=\sqrt{σₗₐₜ²+σ_{long}²} (8)

VDOP=\sqrt{σₐₗₜ²} (9)

Where HDOP (Horizontal DOP) refers to the DOP along the plane of the earth in latitude and longitude; while VDOP refers to the vertical DOP i.e. in the altitude, and PDOP refers to the position DOP consisting of altitude, latitude and longitude. σₗₐₜ² is the variance in latitude, σ_{long}² is the variance in longitude and σₐₗₜ² is the variance in altitude. Computing σₓ, σ_{y}, σ_{z} to σₗₐₜ, σ_{long}, σₐₗₜ requires conversion from earth centric coordinate system to geodetic coordinate system and is well known to the ones skilled in the art. The abovementioned model will determine from which altitude orbits, the CMSs should be chosen to have a minimum error in computed PDOP.

In an embodiment, satellites in medium earth orbit are used to form or augment the configuration of CMSs that receive the positioning signal and transmit the Tₐᵣᵣᵢᵥ to position computation entity.

In an embodiment, satellites in geosynchronous earth orbit are used to form or augment the configuration of CMSs that receive the positioning signal and transmit the Tₐᵣᵣᵢᵥ to position computation entity.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of verifying geolocation coordinates of a user equipment (UE) in a communication system of non-terrestrial networks including a plurality of cluster member satellites (CMSs), comprising:
receiving, for each CMS, (i) a time of transmission of a positioning signal transmitted by the UE (Tₜᵣₐₙₛ), (ii) a time of arrival of the positioning signal at the CMS (Tₐᵣᵣᵢᵥ), and (iii) a position of the CMS;
determining a first geolocation of the UE based on the Tₜᵣₐₙₛ, the Tₐᵣᵣᵢᵥ, and the position of each of the CMSs using a trilateration location calculation method;
determining a second geolocation of the UE based on the Tₐᵣᵣᵢᵥ and the position of each of a configuration of the CMSs comprising one or more of the CMSs using a time difference of arrival location calculation method;
determining a difference between the first geolocation and the second geolocation; and
determining that the positioning signal is malicious if the difference is greater than or equal to a threshold.

2. The method according to claim 1, further comprising determining that the positioning signal is verified if the difference is less than the threshold, and responsive thereto causing one or both of the first geolocation or the second geolocation to be stored in a database.

3. The method according to claim 1, further comprising selecting one or more of the CMSs that will minimize a dilution of a precision of the determination of the second geolocation, wherein the configuration includes only the selected one or more of the CMSs.

4. The method according to claim 3, wherein the selected one or more of the CMSs are not coplanar.

5. The method according to claim 1, wherein the configuration is formed by CMSs in low earth orbits.

6. The method according to claim 1, wherein the configuration is formed by CMSs in medium earth orbit.

7. The method according to claim 1, wherein the configuration is formed by CMSs in geosynchronous orbit.

8. The method according to claim 1, wherein the configuration is formed by a combination of CMSs in two or more of low earth orbit, medium earth orbit, and geosynchronous orbit.

9. The method according to claim 1, wherein the threshold is determined by an upper bound on geolocation coordinates that a malicious entity can misrepresent to a serving one of the CMSs due to accuracy limitations of the time difference of arrival location calculation method.

10. A system for verifying geolocation coordinates of a user equipment (UE) in a communication system of non-terrestrial networks including a plurality of cluster member satellites (CMSs), comprising:
computerized position computation entity having a number of processors, the computerized position computation entity being structured and configured for: receiving, for each CMS, (i) a time of transmission of a positioning signal transmitted by the UE (Tₜᵣₐₙₛ), (ii) a time of arrival of the positioning signal at the CMS (Tₐᵣᵣᵢᵥ), and (iii) a position of the CMS;
determining a first geolocation of the UE based on the Tₜᵣₐₙₛ, the Tₐᵣᵣᵢᵥ, and the position of each of the CMSs using a trilateration location calculation method;
determining a second geolocation of the UE based on the Tₐᵣᵣᵢᵥ and the position of each of a configuration of the CMSs comprising one or more of the CMSs using a time difference of arrival location calculation method;
determining a difference between the first geolocation and the second geolocation; and
determining that the positioning signal is malicious if the difference is greater than or equal to a threshold.

11. The system according to claim 10, the computerized position computation entity being structured and configured for determining that the positioning signal is verified if the difference is less than the threshold, and responsive thereto causing one or both of the first geolocation or the second geolocation to be stored in a database.

12. The system according to claim 10, the computerized position computation entity being structured and configured for selecting one or more of the CMS s that will minimize a dilution of a precision of the determination of the second geolocation, wherein the configuration includes only the selected one or more of the CMSs.

13. The system according to claim 12, wherein the selected one or more of the CMSs are not coplanar.

14. The system according to claim 10, wherein the configuration is formed by CMSs in low earth orbits.

15. The system according to claim 10, wherein the configuration is formed by CMSs in medium earth orbit.

16. The system according to claim 10, wherein the configuration is formed by CMSs in geosynchronous orbit.

17. The system according to claim 10, wherein the configuration is formed by a combination of CMSs in two or more of low earth orbit, medium earth orbit, and geosynchronous orbit.

18. The system according to claim 1, wherein the threshold is determined by an upper bound on geolocation coordinates that a malicious entity can misrepresent to a serving one of the CMSs due to accuracy limitations of the time difference of arrival location calculation method.
